(19) United States
(12) Patent Application Publication
(10) Pub. No.: US 2018/0150189 A1
(43) Pub. Date: May 31, 2018

(54) FAMILY CULTURAL CONTENTS SERVICE METHOD AND SYSTEM

(71) Applicant: San GO, Seoul (KR)

(72) Inventor: San GO, Seoul (KR)

(21) Appl. No.: 15/580,091

(22) PCT Filed: Jun. 8, 2016
(86) PCT No.: PCT/KR2016/006058

§ 371 Date: Dec. 6, 2017

(30) Foreign Application Priority Data
Jun. 9, 2015 (KR) 10-2015-0081154

(51) Int. Cl. G06F 3/0482; G06F 3/0484; G06F 3/0481; G06Q 50/00; G06Q 30/06

(52) U.S. Cl. CPC G06F 3/0482; G06F 3/04842; G06Q 30/0601; G06F 3/04817; G06Q 50/01; G06F 3/04815

(57) ABSTRACT

The present invention relates to a family cultural contents service method and system which, when a user captures (shuts) a photograph or video related to the user's family using a smartphone and posts same in real time on a family cultural space, allow members of the user's family to respectively check the photograph or video by using their own terminals or participate with a reply or a message responding to the posted contents and by using other contents, so as to form a family history. The family cultural contents service system according to the present invention is characterized by comprising: a contents collecting unit for collecting uploaded image data acquired in real time from a user terminal; a shut-tree generating unit for generating a shut-tree when the image data is uploaded; a space forming unit for forming a 3D space corresponding to the shut-tree; a service providing unit for providing a family cultural contents service in the 3D space corresponding to the shut-tree; and a controller for controlling to generate a shut-tree when uploaded image data is received in real time from the user terminal, or generate a 3D space corresponding to the shut-tree and provide a family cultural contents service in the 3D space.

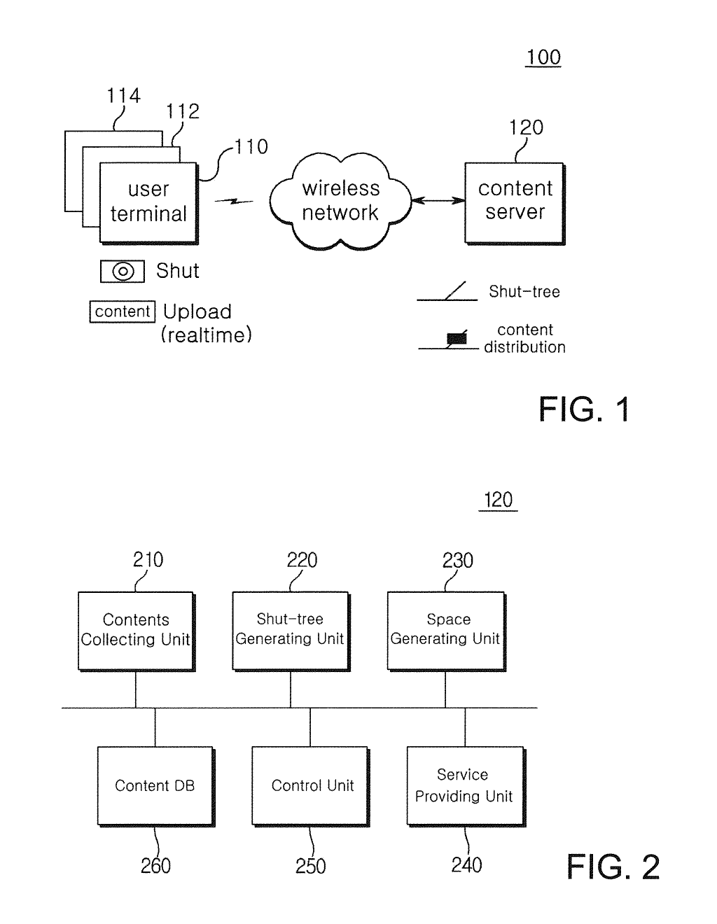

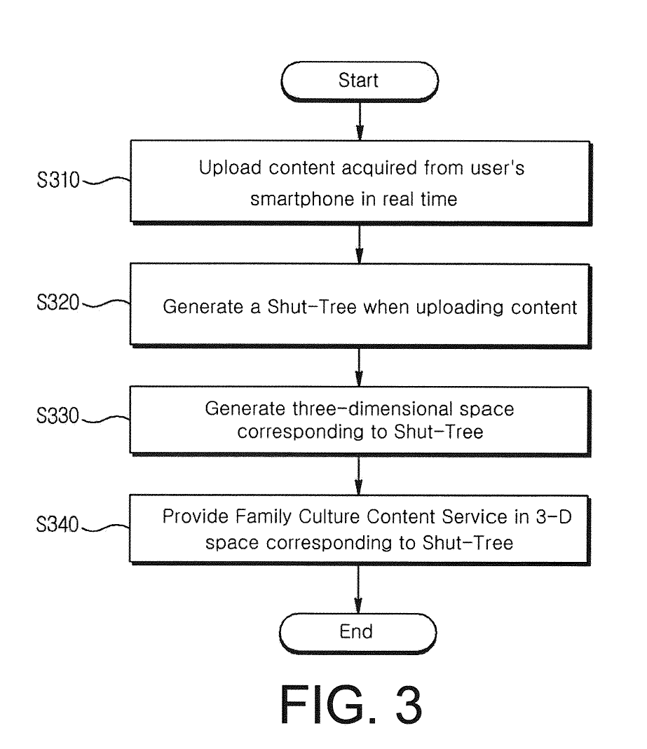

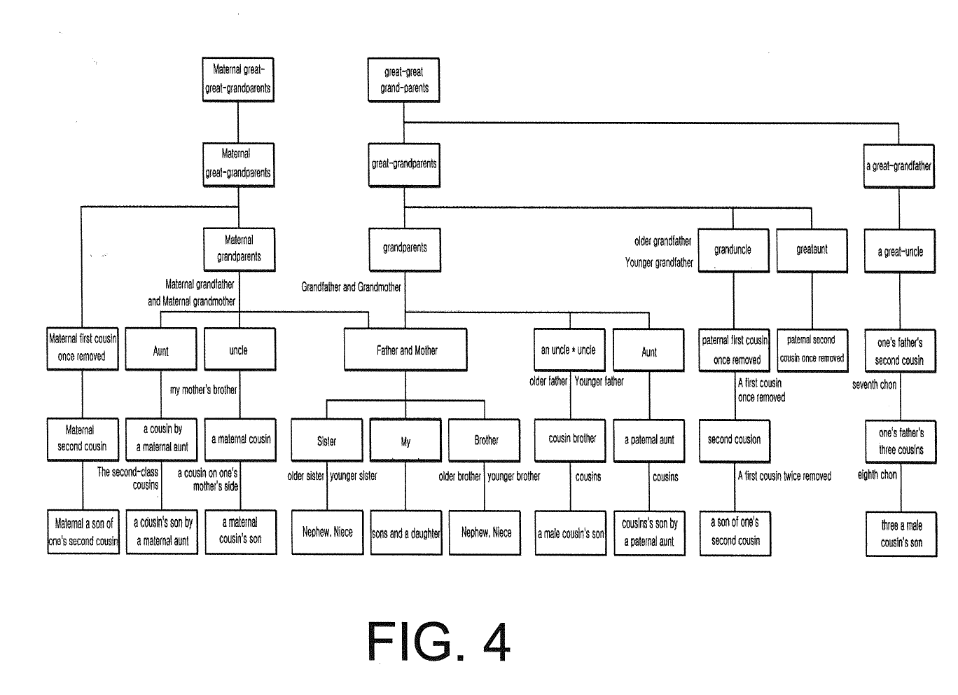

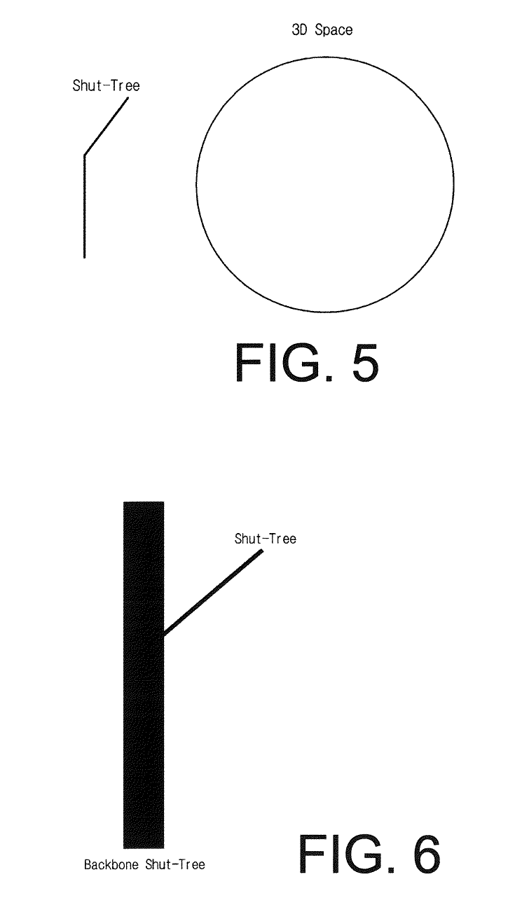

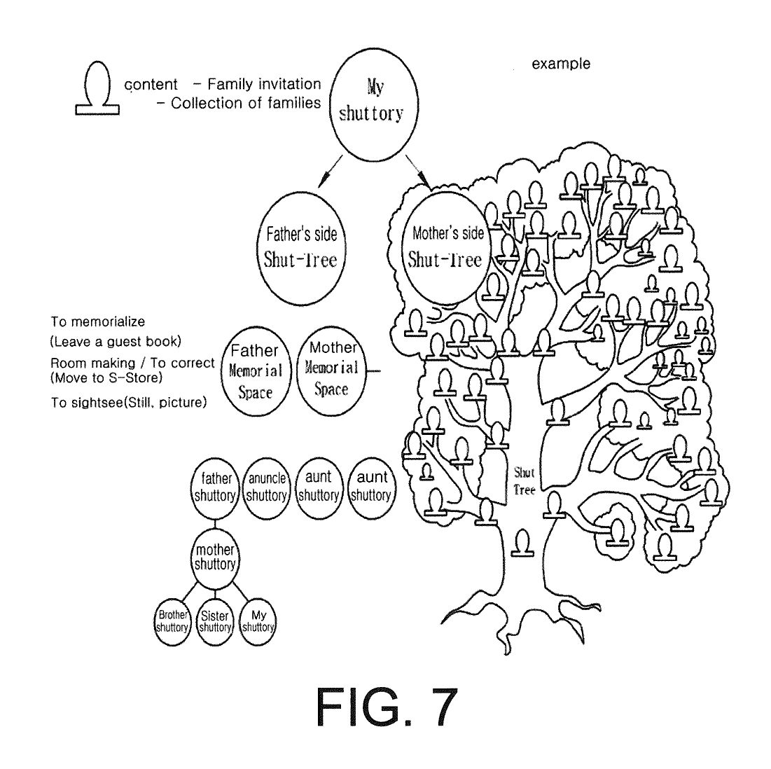

### TECHNICAL FIELD

The present invention relates to a Family Culture Contents Service Method and System to check a family concerned with a user with their own terminal or to be able to create history by participating in comments, messages and other contents, etc. in correspondence with posted contents when a user takes a picture or a video related to a family by using a smart phone and displays it on the family cultural space in real time.

### TECHNICAL BACKGROUND

As the industry develops, the extended family is reduced by increasing the social activity of the people and family bonds gradually disappear in favor of the nuclear and the definition of family becomes blurred.

As a result, family events are reduced, family members are also less likely to have family gatherings on a busy schedule, and sometimes they can not even see seriously each other.

As the Internet is emerging, on the other hand, the service that family members can check for family members or family information at web site or can substitute for family on the Internet in order to restore such family ties is provided.

In other words, in case that there is a situation where an individual or a person who belongs to a company or organization cannot participate in family gatherings or events such as an anniversary of an ancestor's death due to unavoidable circumstances, a service which allows them to participate through a cyberspace gathering site on the Internet is available.

However, in addition to simply participating in the family member meetings and inducing continuous participation, these methods have the problem that they can't actually experience the definition of love and family amongst the family members and can't receive various contents.

### DETAILED DESCRIPTION OF THE INVENTION

### Technical Challenge

The purpose of the present invention is to solve the above-mentioned problems; it relates to a Family Culture Contents Service System to check a family concerned with a user with their own terminal or to be able to create history by participating in comments, messages and other contents, etc. in correspondence with posted contents when a user takes a picture or a video related to a family by using a smart phone and displays it on the family cultural space in real time.

### Task Solution Method

In order to achieve the objectives mentioned beforehand, the Family Culture Contents Service System according to the present invention, it provides a Content Collecting Unit for uploading and collecting image data obtained in real time from the user terminal; a shut-tree generating unit for generating a shut-tree when the image data is uploaded; a space generating unit for generating a three-dimensional space which is connected to a shut-tree; a service providing a Family Culture Contents Service in a three-dimensional space which is connected to a shut-tree; and a control unit for generating a shut-tree when uploading the real-time image data from the user terminal, or generating a three-dimensional space in the shut-tree and providing a Family Culture Contents Service in a three-dimensional space. In addition, the content database that stores image data and Family Culture Contents Service data uploaded from the user terminal can be further included.

In addition, the Family Culture Contents Service runs the uploaded image data from the created shut-tree, of which when clicking on the image run on the shut-tree, it enters into the three-dimensional space connected to the shut-tree where it is possible to set the contents including the background, icon, character, font, background music and image of the three-dimensional space; and therefore can display the contents including the background, icon, character, font, background music (BGM) and image set in the three-dimensional space.

In addition, the user terminal may include a family terminal related to genealogy, and the content database may include a table in which genealogy, family information, and terminal information are matched in a certain number of units. In addition, the content collecting unit may receive the image data from the user terminal in real time through the Family Culture Contents Service application for clients installed in the user terminal. In addition, the Shut-tree Generating Unit can generate a Backbone Shut-tree inside a Shut-tree. This Shut-tree is generated when an image data is uploaded.

In addition, after creating a shut-tree, when the image data is uploaded in real time from another terminal other than the user terminal after generating the shut-tree, the shut-tree generating unit generates another shut-tree to be connected to the generated shut-tree; or you can create a different shut-tree apart from the created or generated shut-tree.

In addition, after creating a shut-tree, when the image data is uploaded in real time from a terminal of a family member having a predetermined number of family members or more, related to the genealogy after generating the shut-tree, the shut-tree generating unit generates another shut-tree to be connected to the generated shut-tree; or you can create a different shut-tree apart from the created or generated shut-tree.

In addition, in response to a request from the user terminal, the control unit invites the user to subscribe to the Family Culture Contents Service through synchronization with a number of a family member or a relative related to the genealogy stored in the terminal or via a text message. If so, connect and create a new shut-tree through the invitation and accept the process if there is no preregistered account, and control to connect or create a duplicate shut-tree to the new account.

In addition, when the number of the family or relatives related to the genealogy stored in the terminal is missing or changed according to the request of the user terminal, the control unit invites the relatives to subscribe to the Family Culture Contents Service that match 2 or more of the data from the name, date of birth, place of residence, and exiting contacts, and creates a new shut-tree through an invitation and acceptance process.

In addition, the control unit provides the shut-tree, which is turned on to the terminal subscribed to the Family Culture Contents Service, among the terminals of the family or relatives related to the genealogy in an active state, it shows the number of families or relatives involved in the genealogy in the active shut-tree and disabled shut-tree, it encourages family members or relatives who are in the disabled shut-tree to join the Family Culture Contents Service and connects or creates a shut-tree through the invitation and acceptance process. In addition, the space generating unit generates a three-dimensional space which is diverted to family terminals related to genealogy according to the shut-tree connected to the three-dimensional space; the service providing unit displays the background, icon, character, background music (BGM) and image according to the family decorations related to genealogy, decorating private space or decorating memorial space of the Family Culture Contents Service. In addition, the service providing unit associates the Family Culture Contents Service with the contents selling mall or the contents store that sells the contents on-line so that the background, icon, character, font, background music (BGM) and image can be set or displayed in the three-dimensional space.

In addition, the service providing unit has configured its payment with Shuttory Point or Shuttory Coin by sending cash, transfer of money or a credit card use to the user terminal so that the user terminal can purchase a background, icon, character, font, background music (BGM) or image from the contents selling mall or contents store about the Family Culture Contents Service. Also, the service providing unit enters the three-dimensional space communicated with the shut-tree through the connection with the user terminal for the Family Culture Contents Service, and allows to select one from the background, icon, character, font, background music (BGM) and image inserted in the three-dimensional space and move it to another shut-tree or three-dimensional space which is different from the other user terminals.

Meanwhile, the Family Culture Contents Service method in order to achieve the purpose of the present invention, (a) a step of uploading the image data acquired in real time from the user terminal; (b) a step of creating a shut-tree when uploading image data; (c) a step to create a three-dimensional space in the shut-tree; and (d) it makes as its feature of including the step of providing the Family Culture Content Service in the shut-tree connected to the three-dimensional space. In addition, the Family Culture Contents Service runs the above uploaded image data from the created shut-tree, of which when clicking on the image run on the shut-tree, it enters into the three-dimensional space connected to the shut-tree where it is possible to set the contents including the background, icon, character, font, background music and image of the three-dimensional space; and therefore can display the contents including the background, icon, character, font, background music (BGM) and image set in the three-dimensional space.

Also, in step (a), the user terminal may be a terminal of a family member or a relative related to the genealogy. Also, in step (a), the information on the genealogy, family or relatives and the terminal can be matched to a table by the degree of kinship.

Also, in step (a), it may receive the image data from the user terminal in real time through the Family Culture Contents Service application for clients installed in the user terminal.

Also, in step (a), in response to a request from the user terminal, it invites the user to subscribe to the family culture contents service through synchronization with a number of a family member or a relative related to the genealogy stored in the terminal or via a text message. If so, connect and create a new shut-tree through the invitation and accept the process if there is no preregistered account, and connect or create a duplicate shut-tree to the new account.

Also, in step (a), when the number of the family or relatives related to the genealogy stored in the terminal is missing or changed according to the request of the user terminal, it invites the relatives to subscribe to the Family Culture Contents Service that match 2 or more of the data from the name, date of birth, place of residence, and exiting contacts, and creates a new shut-tree through an invitation and acceptance process.

Also, before step (a), it provides the shut-tree, which is turned on to the terminal subscribed to the Family Culture Contents Service, among the terminals of the family or relatives related to the genealogy in an active state, it shows the number of families or relatives involved in the genealogy in the active shut-tree and disabled shut-tree, it encourages family members or relatives who are in the disabled shut-tree to join the Family Culture Content Service and connects or creates a shut-tree through the invitation and acceptance process.

Also, in step (b), it can generate a backbone shut-tree and generate a shut-tree on the backbone shut-tree when creating a shut-tree and uploading an image data.

Also, in step (b), after creating a shut-tree, when the image data is uploaded in real time from another terminal other than the user terminal after generating the shut-tree, it generates another shut-tree to be connected to the generated shut-tree; or you can create a different shut-tree apart from the created or generated shut-tree.

Also, in step (b)m after creating a shut-tree, when the image data is uploaded in real time from a terminal of a family member having a predetermined number of family members or more, related to the genealogy after generating the shut-tree, it generates another shut-tree to be connected to the generated shut-tree; or you can create a different shut-tree apart from the created or generated shut-tree.

Also, in step (c), it generates a three-dimensional space which is connected to family terminals related to genealogy according to the shut-tree connected to the three-dimensional space; in step (d), it displays the background, icon, character, background music (BGM) and image according to the family decorations related to genealogy, decorating private space or decorating memorial space of the Family Culture Contents Service.

Also, in step (d), it associates the Family Culture Contents Service with the contents selling mall or the contents store that sells the contents on-line so that the background, icon, character, font, background music (BGM) and image can be set or displayed in the three-dimensional space.

Also, in step (d), it has configured its payment with Shuttory Point or Shuttory Coin by sending cash, transfer of money or a credit card use to the user terminal so that the user terminal can purchase a background, icon, character, font, background music (BGM) or image from the contents selling mall or contents store about the Family Culture Contents Service. Also, it enters the three-dimensional space communicated with the Shut-tree through the connection with the user terminal for the Family Culture Contents Service, and allows to select one from the background, icon, character, font, background music (BGM) and image displayed in the three-dimensional space and move it to another Shut-tree or three-dimensional space which is different from the other user terminals.

### Invention Efficacy

According to the present invention, when the user shoots (shut) a photo or a video in real time during a meeting or an even related to the family and uploads it to the Family Culture Space, it can create a Family History that the family can share.

In addition, according to the Family Culture Contents Service of the present invention, a user or member of the family can leave a story of their own living in the Family History through the Shuttory and can create a bridge between family members through the Family Culture Space.

In addition, the Family Culture Space is easy to store portrait images and is a place where you may be able to see photos or portraits of the family regardless of the location. In addition, by uploading photos, videos and contents to the Family Culture Space, you may be able to leave a trace of your family history and can be the chance of changing the funeral culture.

In addition, even if the family or the user becomes a senior over the years, the family history can be continued through the Family Culture Space and can recall the past traces of life ‘Blissful Journey’ stored in Shuttory.

Also, you may be able to keep your beautiful memories forever through the Shuttory, the Family Culture Space, and may be able to create an opportunity to recall your past happiness through the Shuttory.

### BRIEF DESCRIPTION OF THE DRAWING

Drawing 1 is a drawing schematically showing the overall concept of the Family Culture Contents Service System according to the embodiment of the present invention.

Drawing 2 is a drawing illustrating an example of the configuration of a contents server in the Family Culture Contents Service System according to the embodiment of the present invention.

Drawing 3 is a flow diagram illustrating the method of providing a Family Culture Contents Service according to the embodiment of the present invention.

Drawing 4 is a drawing illustrating an example of genealogy applied to the Family Culture Contents Service according to the present invention.

Drawing 5 is a drawing illustrating an example of the generated Shuttory and its corresponding three-dimensional space according to the embodiment of the present invention.

Drawing 6 is a drawing illustrating an example of the generated Shuttory, the Backbone Shut-tree and the Shut-tree connected to it according to the embodiment of the present invention.

Drawing 7 is a drawing illustrating an example of the generating Shut-tree in units of families and the contents of the Shut-tree according to the embodiment of the present invention.

### BEST MODE FOR CARRYING OUT THE INVENTION

Hereinafter, exemplary embodiments of the present invention will be described in detail with reference to the accompanying drawings, which will be readily apparent to those skilled in the technique to which this present invention pertains. The present invention may be embodied in many different forms and is not limited to the embodiments described herein. In order to specifically illustrate the present invention, unrelated parts to the description have been omitted, and same reference numerals will be used for the same or similar components through the entire specification. Throughout the specification, when a part is referred to as being “connected” to another part, it includes not only the case of being “directly connected” but also when it is “regularly connected” with another part in between. Also, when a part is referred to as “including” a component, it means that unless it is specifically stated otherwise, it does not exclude other components but it includes the other components.

In case a part is referred to as being “above” the other part, it means that it may be directly on top of the other part or may involve another parts therebetween. In contrast, when a part is referred to as being “directly above” another part, it means that there is no other part that is involved.

The terms of first, second, third and etc., are used to describe various parts, components, regions, layers and/or sections, but are not limited thereto. These terms are only used to distinguish a part, component, region, layer or section from another part, component, region, layer or section. Accordingly, the first part, component, region, layer or section described below, may be referred to as the second part, component, region, layer or section without departing from the scope of the present invention.

The terminology used herein is for the sole purpose of describing particular embodiments and is not intended to limit the present invention. The singular forms used herein include plural forms as well, provided that the phrases do not expressly have the opposite meaning. The definition of the word “including” used in the specification materializes the particular feature, region, integer, step, operation, constituent and/or component and does not exclude the presence or absence of other features, regions, integers, steps, operations, constituents and/or components.

Terms indicating relative space, such as “below”, “above” and others, can be used to describe more easily the relationship of a part to another part shown in the drawing. These terms are intended to include alternative meanings or motions of the apparatus in use, as well as intended meanings in the drawings. For example, when inverting the device in the drawing, certain parts that are described as being “below” can be described as being “above”. Accordingly, the exemplary term “below” includes both up and down directions. The device can be rotated by 90° or rotated at different angles, and the term indicating the relative space is interpreted accordingly.

Unless defined otherwise, all terms including technical and scientific terms used herein have the same definition as commonly understood by one of ordinary skill in the technique to which the present invention belongs. The commonly used predefine terms are further interpreted as having a meaning consistent with the relevant technology literature and the present disclosure, are not to be construed as ideal or as in a formal meaning unless defined otherwise.

Hereinafter, exemplary embodiments of the present invention will be described in detail in reference to the accompanying drawings, which will be readily apparent to those skilled in the technique to which this present invention pertains. However, this present invention may be embodied in many different forms and is not limited to the embodiments described herein.

Drawing 1 is a drawing schematically showing the overall concept of the Family Culture Contents Service System according to the embodiment of the present invention.

The Family Culture Contents Service according to the embodiment of the present invention, is described to be comprised of people who have a personal relationship with the user, in other words, members who are listed in the genealogy and registered in the Family Culture Contents Service; but it is not limited to this and can be ‘friends’ or have a special relationship through the SNS.

The Family Culture Contents Service according to the embodiment of the present invention, is a service where people listed in the genealogy register to the Family Culture Space as a member of which their database is stored by matching name, social security number, phone number, smart phone number, address and others; where the user can use the smart phone to photograph and/or upload family-related photos or videos on the application in real time, where a Shut-tree is automatically created for the user who has uploaded the contents in the Family Culture Space, where in the generated Shut-tree, a three-dimensional space in the form of a room that the user can decorate with contents is automatically created and where the family members related to the user can see the contents uploaded in the Shut-tree on their own devices and can comment and message and participate in other contents, thus creating a Family History.

In this sense, the name of ‘Shuttory’ has been given from the concept of when families take a picture (Shut) and create a Family History (History) in real time, and the Family Culture Contents Service has been named ‘Shuttory Service’. Referring to Drawing 1 for such Shuttory Services, the Family Culture Contents System (100) according to the embodiment of the present invention, includes at least one user terminal (110˜114) carried by a family and a Contents Server (120) that provides the Family Culture Contents Service.

The user terminal (110˜114) is a portable terminal carried by family members; for example, a smart phone having the function of taking pictures or videos can be taken as an example. In addition, the user terminal (110˜114) has the Family Culture Contents Service application for clients installed in order to use the ‘Shuttory Service’, and can take pictures or videos on the spot and transmit them to the Contents Server (120) in real time through the client-use application.

At this time, the user terminal (110˜114) has to download and install the Family Culture Contents Service application for clients for the Shuttory Service from the Contents Server (120).

The wireless communication network includes a wireless Internet and a mobile communication network capable of transmitting and receiving voice and data. When the Contents Server (120) receives the uploads such as a photograph, video or contents from the user terminal (110˜114), it creates a Shut-tree to display the uploaded content and creates a three-dimensional space in the form of a room so that it can be decorated with contents. Then, the Contents Server (120) displays the uploaded content on the newly created Shut-tree, and informs all the family members subscribed to the Shuttory Service that a content has been newly published.

Accordingly, the family members related to the user can check and see the contents displayed in the Shut-tree through the Family Culture Contents Service application for clients on their own terminals, or participate in the posted contents with comments, messages, and other.

On the other hand, other members of the family can also acquire the contents such as photos and videos using their own user terminals and upload them to the Contents Server (120) in real time. Accordingly, in order to display the uploaded contents from the Contents Server (120), a Shut-tree and a three-dimensional space is created. Accordingly, the Contents Server (120) displays the contents uploaded to the newly created Shut-tree, as new Shut-trees are continuously generated, each family member creates a Family History on the Family Culture Space provided by the Contents Server (120).

For example, the Contents Server (120) can provide a Family Culture Space of a certain size in units of one genealogy, and can allocate a three-dimensional space together with generation of Shut-trees for each individual in the provided Family Culture Space

In addition, the Contents Server (120) creates a Shut-tree and a three-dimensional space whenever each family member uploads a content in real time, where you can create a whole Family Culture Space for your family by adding new Shut-trees and a three-dimensional space.

Drawing 2 is a drawing illustrating an example of the configuration of a contents server in the Family Culture Contents Service System according to the embodiment of the present invention.

Referring to Drawing 2, the Contents Server (120) according to the present invention, includes the Contents Collecting Unit (210), Shut-tree Generating Unit (220), Space Generating Unit (230), Service Providing Unit (240), Control Unit (250) and the Contents Database (260).

Here, the Contents Server (120) can be referred to as a ‘Contents service device’ that provides the Family Culture Contents Service, and may also be referred to as ‘Contents device’ or ‘Service device.’

The Contents Collecting Unit (210) uploads and collects image data obtained in real time from the user terminal (110˜114). In addition, the Contents Collecting Unit (210) may receive the image data from the user terminal in real time through the Family Culture Contents Service application for clients installed in the user terminal.

The Shut-tree Generating Unit (220) generates a Shut-tree upon the upload of an image data. In addition, the Shut-tree Generating Unit (220) can generate a backbone shut-tree and generate a shut-tree on the backbone shut-tree when creating a shut-tree and uploading an image data. In addition, after creating a Shut-tree, when the image data is uploaded in real time from another terminal other than the user terminal, the Shut-tree Generating Unit (220) generates another Shut-tree to be connected to the generated Shut-tree; or you can create a different Shut-tree apart from the created or generated Shut-tree.

In addition, after creating a shut-tree, when the image data is uploaded in real time from a terminal of a family member having a predetermined number of family members or more, related to the genealogy after generating the shut-tree, the Shut-tree Generating Unit (220) generates another shut-tree to be connected to the generated shut-tree; or you can create a different shut-tree apart from the created or generated shut-tree.

The Space Generating Unit (230) generates a three-dimensional space that is connected to the Shut-tree. Here, the three-dimensional space can be a space having a width, height and length, can be a space according to the function viewed in a three-dimensional space by an image processing method and can be generated in a vector manner. Although the Space Generating Unit (230) is separately configured according to a functional method, it can be implemented by a function of processing from the Control Unit (250) without being separately configured. It may be preferable to separately configure the functions of the Control Unit (250) in order to reduce the processing load.

The Service Providing Unit (240) provides a Family Culture Contents Service in a three-dimensional space that is mutually exclusive to a Shut-tree. Here, the Family Culture Contents Service runs the above uploaded image data from the created shut-tree, of which when clicking on the image run on the shut-tree, it enters into the three-dimensional space connected to the shut-tree where it is possible to set the contents including the background, icon, character, font, background music and image of the three-dimensional space; and therefore can display the contents including the background, icon, character, font, background music (BGM) and image set in the three-dimensional space.

In addition, the Space Generating Unit (230) generates a three-dimensional space which is diverted to family terminals related to genealogy according to the shut-tree connected to the three-dimensional space; the Service Providing Unit (240) displays the background, icon, character, background music (BGM) and image according to the family decorations related to genealogy, decorating private space or decorating memorial space of the Family Culture Contents Service.

In addition, the Service Providing Unit (240) associates the Family Culture Contents Service with the contents selling mall or the contents store that sells the contents on-line so that the background, icon, character, font, background music (BGM) can be set or displayed in the three-dimensional space.

In addition, the Service Providing Unit (240) has configured its payment with Shuttory Point or Shuttory Coin about the Family Culture Contents Service by sending cash, transfer of money or a credit card use to the user terminal so that the user terminal can purchase a background, icon, character, font, background music (BGM) or image from the contents selling mall or contents store.

Also, the Service Providing Unit (240) enters the three-dimensional space communicated with the Shut-tree through the connection with the user terminal for the Family Culture Contents Service, and allows to select one from the background, icon, character, font, background music (BGM) and image displayed in the three-dimensional space and move it to another shut-tree or three-dimensional space which is different from the other user terminals.

The Control Unit (250) controls the generation of a Shut-tree or a three-dimensional space, or provides a Family Culture Contents Service in the three-dimensional space when it receives an upload of an image data from the user terminal in real time. In addition, in response to a request from the user terminal, the Control Unit (250) invites the user to subscribe to the Family Culture Contents Service through synchronization with a number of a family member or a relative related to the genealogy stored in the terminal or via a text message. If so, connect and create a new shut-tree through the invitation and accept the process if there is no preregistered account, and control to connect or create a duplicate shut-tree to the new account.

In addition, when the number of the family or relatives related to the genealogy stored in the terminal is missing or changed according to the request of the user terminal, the Control Unit (250) invites the relatives to subscribe to the Family Culture Contents Service that match 2 or more of the data from the name, date of birth, place of residence, and exiting contacts, and creates a new shut-tree through an invitation and acceptance process.

In addition, the Control Unit (250) provides the shut-tree, which is turned on to the terminal subscribed to the Family Culture Contents Service, among the terminals of the family or relatives related to the genealogy in an active state, it shows the number of families or relatives involved in the genealogy in the active shut-tree and disabled shut-tree, it encourages family members or relatives who are in the disabled shut-tree to join the Family Culture Content Service and connects or creates a shut-tree through the invitation and acceptance process. The Contents Database (260) stores the image data and data related to the Family Culture Contents Service uploaded from the user terminal.

The User Terminal (110˜114) may include a family terminal related to genealogy, and the Content Database (260) may include a table in which genealogy, family information, and terminal information are matched in a certain number of units.

Drawing 3 is a flow diagram illustrating the method of providing a Family Culture Contents Service according to the embodiment of the present invention. First, the Family Culture Contents Service according to the embodiment of the present invention, can be provided for members who are registered as one family unit within the 3rd degree of kinship in proportion to the genealogy as shown in Drawing 4. Drawing 4 is a drawing illustrating an example of genealogy applied to the Family Culture Contents Service according to the present invention. In Drawing 4, it is possible to register the father, mother, brother, sister, son, daughter, nephew and niece as a family member (1st family) centered in I (myself), and can also register the maternal side of the family, such as the grandparents, aunt, cousins, and others of the maternal side as another family member (2nd family). In addition, in Drawing 4, a member of the father's family, that is, grandparents, uncle, aunt and cousins of the paternal side can register as another family (3rd family).

By being registered to the Family Culture Contents Service on a family unit basis, one person of the 1st, 2nd and 3rd family can upload photos and videos taken during family gatherings or events to the Contents Server (120) in real time through the User Terminal (110) carried by the user.

The Contents Server (120) matches the name, social security number, telephone number, smart phone number, address and the like of the users registered in the Family Culture Contents Service and stores them into the Contents Database (260).

Referring to Drawing 3, the Family Culture Contents Service System (100) according to the present invention, acquires the contents such as a photograph or a video on-site and uploads the contents to the Contents Server (120) in real-time; the Contents Server (120) uploads the contents obtained in real-time from the user terminal (110) (S310).

In other words, the Contents Collecting Unit (210) of the Contents Server (120) uploads and collects the contents transmitted in real-time from the user terminal (110), and stores the collected contents into the Contents Database (260).

Here, the User Terminal (110) can be a terminal carried by a family member related to the genealogy.

At this time, the Contents Database (260) the information of the family and the terminal are matched and stored according to the degree of kinship unit. In addition, the Contents Collecting Unit (210) of the Contents Server (120) may receive the image data from the User Terminal (110) in real time through the Family Culture Contents Service application for clients installed in the user terminal.

In addition, when the Contents Server (120) uploads the content from the User Terminal (110) in real-time, information of the User Terminal (110) is also uploaded together with the content. Then, the Contents Server (120) creates a Shut-Tree when uploading the content (S320). That is, the Contents Server (120) generates a Shut-tree through the Shut-tree Generating Unit (220) for the content distribution on the Family Culture Space allocated to the family members of the User Terminal (110) as shown in Drawing 5. Drawing 5 is a drawing illustrating an example of the generated Shuttory and its corresponding three-dimensional space according to the embodiment of the present invention.

At this time, the Shut-tree Generating Unit (220) generates a Backbone Shut-tree as shown in Drawing 6 when generating a Shut-tree at the time of uploading a content, and can create shuttles in side-by-side fashion in the Backbone Shut-tree. Drawing 6 is a drawing illustrating an example of the generated Shuttory, the Backbone Shut-tree and the Shut-tree connected to it according to the embodiment of the present invention.

In addition, after creating a Shut-tree, when the image data is uploaded in real-time from another terminal other than the user terminal, the Shut-tree Generating Unit (220) generates another Shut-tree to be connected to the already generated Shut-tree; or you can create a different Shut-tree apart from the already created or generated Shut-tree.

In addition, after creating a shut-tree as shown in Drawing 7, when the content is uploaded in real time from a terminal of a family member having a predetermined number of family members or more, related to the genealogy after generating the shut-tree, the Shut-tree Generating Unit (220) generates another shut-tree to be connected to the already generated shut-tree; or you can create a different shut-tree apart from the created or generated shut-tree. Drawing 7 is a drawing illustrating an example of the generating Shut-tree in units of families and the contents of the Shut-tree according to the embodiment of the present invention. As shown in Drawing 7, the Family Culture Contents Service according to the present invention can create a Shut-tree according to the genealogy shown in Drawing 4 in addition to the user's own Shut-tree (My Shuttory). In addition, the User Terminal (110) can invite other members who have not yet joined by inviting the other terminals (112˜114) to subscribe to the Family Culture Contents Service according to the user's request.

In response to the request from the user terminal, the Control Unit (150) of the Contents Server (120) can synchronize with the number of the family or relative involved in the genealogy or can invite them to join the Family Culture Contents Service through text messages. At this time, if there is an existing account, it can connect or create a new Shut-tree through the invitation and acceptance process, and if there is no existing account, in addition to creating a new account through the invitation and acceptance process, you can connect or create a duplicate Shut-tree in the new account.

In addition, when the number of the family or relatives related to the genealogy stored in the terminal is missing or changed according to the request of the user terminal, the Control Unit (250) invites the relatives to subscribe to the Family Culture Contents Service that match 2 or more of the data from the name, date of birth, place of residence, and exiting contacts, and can create a new Shut-tree through an invitation and acceptance process.

In addition, the Control Unit (250) provides the Shut-tree, which is communicated to the terminal subscribed to the Family Culture Contents Service, among the terminals of family members or relatives related to the genealogy in an activated state, provides the user terminal with a Shut-tree that is deactivated in the vicinity, and controls the display of the number of siblings of family or relatives involved in the genealogy in the activated state of the Shut-tree and in the deactivated Shut-tree. At this time, the Control Unit (250) invites a family member or relatives connected to the deactivated Shut-tree to subscribe to the Family Culture Contents Service according to the request of the User Terminal, and controls the connection and generation of a new Shut-tree through the invitation and acceptance process.

Then, the Contents Server (120) generates a three-dimensional space which is a variant of the newly generated Shut-tree through the Space Generating Unit (230) as shown in Drawing 5 (S330).

Here, the Space Generating Unit (230) creates a three-dimensional space variant to the family related to the genealogy or to the terminal of the family related to the genealogy according to the three-dimensional space variant to the Shut-tree. At this time, the three-dimensional space can generate a room-type space or a memorial space in which the User Terminal (110) enters and decorates with contents including background, icon, character, background music, and images. In addition, the Space Generating Unit (230) can generate a three-dimensional space at the moment when the content is uploaded from the User Terminal (110) or at the moment when the content is displayed in the Shut-tree. However, it is possible to generate a three-dimensional space variant to the user's information upon the request of the User Terminal (110).

The Contents Server (120) provides a Family Culture Contents Service in a three-dimensional space that is mutually exclusive to a Shut-tree (S340). Here, the Family Culture Contents Service runs the above uploaded contents from the created Shut-tree, of which when the user clicks on the content run on the shut-tree, it enters into the three-dimensional space connected to the shut-tree where it is possible to set the contents including the background, icon, character, font, background music and image of the three-dimensional space; and therefore can display the contents including the background, icon, character, font, background music (BGM) and image set in the three-dimensional space.

In addition, the Contents Server (120) of the Family Culture Contents Service, can set or display the background, icon, character, font, background music (BGM), or image in accordance with the decoration of the personal space or memorial space in the three-dimensional space by a family terminal related to the genealogy. Here, the three-dimensional space can be referred to as ‘Shuttory Land’ or ‘Memorial Shuttory’ by applying the concept of the present invention. Accordingly, when a user uploads contents such as a photograph and videos related to the family since their youth by using the Family Culture Contents Service according to the embodiment of the present invention, when time has passed and you are old, you will be able to see the ‘Blissful Journey’ and recall your past life and see the traces you have left in Shuttory through the Family Culture Space.

Also, the Contents Server (120) associates the Family Culture Contents Service with the contents selling mall or the contents store that sells the contents on-line so that the background, icon, character, font, background music (BGM) or image can be set or displayed in the three-dimensional space. Here, the contents selling mall or the contents store can be referred to as a ‘Shut Store’ or a ‘Shuttory Mall’ by applying the concept of the present invention.

In addition, the Contents Server (120) has configured its payment with Shuttory Point or Shuttory Coin about the Family Culture Contents Service by sending cash, transfer of money or a credit card use to the user terminal so that the user terminal can purchase a background, icon, character, font, background music (BGM) or image from the contents selling mall or contents store. Here, in addition to the Shuttory Point or Shuttory Coin, it can be called as ‘Shut Coin’, ‘Shut Point’ or ‘Shut Pay’. Also, the Contents Server (120) enters the three-dimensional space communicated with the Shut-tree through the connection with the user terminal for the Family Culture Contents Service, and allows to select one from the background, icon, character, font, background music (BGM) and image displayed in the three-dimensional space and move it to another shut-tree or three-dimensional space which is different from the other user terminals through a gift function.

As described above, according to the present invention; when a user takes a photo or a video related to a family using a smart phone and displays it on the Family Culture Space in real-time, families related to the user can check their own terminals, of which a Family Culture Contents Service Method and System can be realized that allows a participant to participate in a posted content through a comment, message, or other contents to create a Family History.

It should be understood by those skilled in the technique that the above-described embodiments of this present invention are illustrative in all aspects and not restrictive and there may be various changes in forms and details. The scope of the present invention is defined by the appended claims rather than the detailed description, and all changes or modifications derived from the meaning and scope of the claims and equivalents thereof are to be construed as being included within the scope of the present invention.

1-28. (canceled)

29. A family culture contents service method for transmitting and receiving data through a communication network with a user terminal, said method comprising:
(a) the step of registering as a member of family culture contents service when the information of a family member is input from a user terminal in a service providing unit;
(b) the step of generating a backbone shuttree from a shuttree generating unit according to the user mentioned beforehand, and generates a shuttree for the family members in a side-by-side manner, respectively;
(c) the step of activating the shuttree in a side-by-side manner of the family members when a control unit activates the backbone shuttree mentioned beforehand, and the family members register to the family culture contents service;
(d) the step of generating a personal space in an image processing or vector system in correspondence with the activated backbone shuttree or a side-branch type from the space generating unit;
(e) the step of receiving the contents from the terminal of the user or of a family member in a contents collecting unit;
(f) the step of displaying the uploaded content from the service providing unit into the personal space corresponding to the activated backbone shuttree or the side-by-side shuttree; and
(g) the step of providing a service for sharing personal space among family members;
wherein the above-mentioned service providing unit provides the service of decorating a personal space using the published contents by the terminal of the user or of the family members, and allows that the contents can be moved to another personal space in cooperation with the user terminal and the terminal of the family member.

30. The family culture contents service method according to claim 29, in which, in the step of registering as a member of family culture contents service, a family culture contents service matches the family genealogy information of the user and of the family members mentioned beforehand with a degree of kinship unit.

31. The family culture contents service method according to claim 30, in which, in the step of registering as a member of family culture contents service, the membership is performed through an invitation and acceptance process; the service providing unit invites a family member or the terminal of a relative related to the genealogy of the user mentioned beforehand, to subscribe to the family culture contents service through a text message.

32. The family culture contents service method according to claim 30, in which, in the step of registering as a member of family culture contents service, the membership is performed through an invitation and acceptance process; when a number of a family member or a relative's terminal related to the genealogy of the user is not present or changed in the user terminal, the service providing unit mentioned beforehand invites the family members or relatives that match two or more of the information: name, date of birth, address and previous contact number.

33. The family culture contents service method according to claim 29, in which, in the step of generating a backbone shuttree from a shuttree generating unit, after generating a backbone shuttree and when the terminal of the family member other than the user terminal is a member of the family culture contents service, its shuttree generating unit generates a backbone shuttree in a side-by-side manner or generates a new shuttree different from the generated backbone shuttree.

34. The family culture contents service method according to claim 29, in which, in the step of activating the shuttree in a side-by-side manner of the family members, the control unit indicates the number of siblings related to the genealogy in the activated backbone shuttree and the activated and inactivated side-branch type shuttree mentioned beforehand.

35. The family culture contents service method according to claim 34, in which, in the step of activating the shuttree in a side-by-side manner of the family members, the activation of the shuttree is related to a family member when one of them joins the family culture contents service through an invitation and acceptance process; the control unit provides the user terminal with information on a terminal corresponding to the deactivated shuttree among family members or relatives terminals related to the genealogy and invites a family member or a relative's terminal corresponding to the inactivated shuttree to subscribe to the family culture contents service at the request of the user terminal.

36. The family culture contents service method according to claim 29, in which, in the step of displaying the uploaded content from the service providing unit, the service providing unit notifies the terminal of the user and of the family members that the content has been displayed, wherein the terminal of the user and the family members access the personal space to check the posted content and provides a service for allowing the user to participate through a comment, message or other contents corresponding to the posted content.

37. The family culture contents service method according to claim 29, in which, in the step of providing a service for sharing personal space among family members the family culture contents service displays a personal space with its set background, icon, character, background music and image; its service providing unit allows the terminal of the user or of the family members to set a background according to its contents to decorate its own personal space, and also, to select an icon, a character, a background music (bgm) or image.

38. The family culture contents service method according to claim 29, in which, in the step of providing a service for sharing personal space among family members, the service providing unit affiliates with a contents sales mall or a contents store that sells the contents mentioned beforehand on-line, and provides the service of allowing one of the contents such as the background, icon, character, font, background music (bgm), or image to be purchased by the terminal of the user or family members.

39. The family culture contents service method according to claim 38, in which, in the step of providing a service for sharing personal space among family members, the family culture contents service provides the service of displaying their own personal space; the service providing unit allows the selection of a background, icon, character, font, background music (bgm) and image contents purchased by the terminal of the user or of the family members through the contents sales mall or the contents store mentioned beforehand.

40. The family culture contents service method according to claim 39, in which, in the step of providing a service for sharing personal space among family members, the service providing unit provides the service of buying the shuttory point or the shuttory coin through cash, money transfer or credit card to purchase in the contents sales mall or the contents store for the background, icon, character, font, background music (bgm), and image from the terminal of the user or of the family members.

41. The family culture contents service method according to claim 29, in which, in the step of providing a service for sharing personal space among family members, the service providing unit provides the service of allowing the movement of the contents purchased in the contents sales mall or the contents store or the contents displayed in the personal space from the terminal of the user or of the family member to another corresponding shuttree or another personal space.

42. A family culture contents service system comprising:
a contents server for transmitting and receiving data to and from a user terminal via a communication network;
a service providing unit that receives information of family members from the user terminal and performs the registration of the family culture contents service according to the user;
a shuttree generating unit that generates a backbone shuttree for the user and generates a shuttree in a side-by-side branch form for the family members;
a control unit that, when the user terminal joins the family culture contents service, it activates a backbone shuttree, and when one of the family member joins the family culture contents service, it activates a shuttree of the registered family member;
a generating unit that generates a personal space in an image processing or vector system corresponding to the activated backbone shuttree or a shuttree; and
a contents collecting unit for the uploaded contents from the terminal of the user or of the family members who are members of the family culture contents service;
wherein the family culture contents service system provides a service for sharing personal space among family members, the service providing unit provides the service of decorating a personal space using the uploaded contents by the terminal of the user or of the family members, and allows that the contents can be moved to another personal space in cooperation with the user terminal and the terminal of the family member.

43. The family culture contents service system according to claim 42, including a contents database that stores a table in which the genealogy of the user and information of the family members are matched with a degree of kinship unit.

44. The family culture contents service system according to claim 43, in which the contents database stores image data uploaded from the user terminal and data on the family culture contents service.

45. The family culture contents service system according to claim 43, in which membership is performed through an invitation and acceptance process; the service providing unit invites a family member or the terminal of a relative related to the genealogy of the user to subscribe to the family culture contents service through a text message.

46. The family culture contents service system according to claim 42, in which membership is performed through an invitation and acceptance process; when a number of a family member or a relative's terminal related to the genealogy of the user is not present or changed in the user terminal, the service providing unit invites the family members or relatives that match two or more of the information: name, date of birth, address and previous contact number.

47. The family culture contents service system according to claim 42, in which, after generating a backbone shut tree and when the terminal of the family member other than the user terminal is a member of the family culture contents service, the shuttree generating unit generates a backbone shuttree in a side-by-side manner or generates a new shuttree different from the generated backbone shuttree.

48. The family culture contents service system according to claim 42, in which the control unit indicates the number of siblings related to the genealogy in the activated backbone shuttree and the activated and inactivated side-branch type shuttree.

49. The family culture contents service system according to claim 42, in which the family culture contents service system activates the shuttree related to the family member when one of them joins the family culture contents service through an invitation and acceptance process; the control unit provides the user terminal with information on a terminal corresponding to the deactivated shuttree among family members or relatives terminals related to the genealogy and invites a family member or a relative's terminal corresponding to the inactivated shuttree to subscribe to the family culture contents service at the request of the user terminal.

50. The family culture contents service system according to claim 42, in which the service providing unit notifies the terminal of the user and of the family members that the content has been displayed, wherein the terminal of the user and the family members access the personal space to check the posted content and provides a service for allowing the user to participate through a comment, message or other contents corresponding to the posted content.

51. The family culture contents service system according to claim 42, in which the family culture contents service system displays a personal space with its set background, icon, character, background music and image; the service providing unit allows the terminal of the user or of the family members to set a background according to its contents to decorate its own personal space, also, to select an icon, a character, a background music (bgm) or image.

52. The family culture contents service system according to claim 42, in which the service providing unit affiliates with a contents sales mall or a contents store that sells the contents mentioned beforehand on-line, and provides the service of allowing one of the contents such as the background, icon, character, font, background music (bgm), or image to be purchased by the terminal of the user or family members.

53. The family culture contents service system according to claim 42, in which the family culture contents service system provides the service of displaying to users their own personal space; the service providing unit allows selection of a background, icon, character, font, background music (bgm) or image contents purchased by the terminal of the user or of the family members through a contents sales mall or a contents store.

54. The family culture contents service system according to claim 42, in which the service providing unit provides the service of buying the shuttory point or the shuttory coin through cash, money transfer or credit card to purchase in a contents sales mall or a contents store a background, icon, character, font, background music (bgm), or image from the terminal of the user or of the family members.

55. The family culture contents service system according to claim 42, in which the service providing unit provides the service of allowing the movement of the contents purchased in a contents sales mall or a contents store or the contents displayed in the personal space, from the terminal of the user or of the family member to another corresponding shuttree or another personal space.
